(19) United States
(12) Patent Application Publication
(10) Pub. No.: US 2016/0001482 A1
(43) Pub. Date: Jan. 7, 2016

(54) METHOD OF MANUFACTURING MOLDED PRODUCT OF SILANE CROSSLINKED POLYETHYLENE RESIN, METHOD OF MANUFACTURING ROD-SHAPED MOLDED PRODUCT, AND MANUFACTURING APPARATUS THEREFOR

(71) Applicant: MITSUBISHI ELECTRIC CORPORATION, Chiyoda-ku (JP)

(72) Inventors: Shinya NAITO, Chiyoda-ku (JP); Masahiko HIDA, Chiyoda-ku (JP); Michio MURAI, Chiyoda-ku (JP); Toyoki KURODA, Chiyoda-ku (JP)

(73) Assignee: MITSUBISHI ELECTRIC CORPORATION, Chiyoda-ku (JP)

(21) Appl. No.: 14/768,624

(22) PCT Filed: Dec. 24, 2013
(86) PCT No.: PCT/JP2013/084422

§ 371 Date: Aug. 18, 2015

(30) Foreign Application Priority Data
Apr. 19, 2013 (JP) 2013-088366

(51) Int. Cl. B29C 47/04; B29C 47/02; B29C 47/88; B29C 47/00

(52) U.S. Cl. CPC B29C 47/043; B29C 47/0004; B29C 47/0016; B29C 47/025; B29C 47/8815; B29K 2085/00

(57) ABSTRACT

A method of manufacturing a molded product of a silane crosslinked polyethylene resin includes the steps of: melting a silane crosslinked polyethylene resin; extrusion-molding the melted resin; bringing a surface of a molded product obtained by the extrusion molding into contact with an oil-soluble dye solution before at least the surface solidifies; separating the molded product from the oil-soluble dye solution; and cooling the molded product separated from the oil-soluble dye solution. According to the method of manufacturing a molded product of a silane crosslinked polyethylene resin, a molded product of a uniformly-colored silane crosslinked polyethylene resin can be obtained without causing scorching even if a silanol condensation catalyst is blended for molding, and also without impairing productivity since molding and coloring are sequentially carried out.

### TECHNICAL FIELD

The present invention relates to a method of manufacturing a molded product of a silane crosslinked polyethylene resin, a method of manufacturing a rod-shaped molded product of a silane crosslinked polyethylene resin, and a manufacturing apparatus therefor.

### BACKGROUND ART

A silane crosslinked polyethylene resin allows easy crosslinking of molecular chains, has excellent thermal characteristics, chemical characteristics and mechanical characteristics, and is applied for example to many cases such as a power cable, a water pipe and the like.

As a method conventionally used for coloring a resin molded product, color masterbatch pellets formed of condensed pigments, dye or the like are blended using a method such as dry-blending during molding, and then melt-kneaded and molded. However, pigments (for example, carbon black in the case of a black color) and dye generally have hygroscopic properties, and color masterbatch pellets formed of condensed pigments or dye also have hygroscopic properties. Accordingly, in the case of molding a resin composition such as silane crosslinked polyethylene that undergoes a crosslinking reaction promoted by moisture and heat, when color masterbatch pellets are blended and molded, a premature crosslinking phenomenon (scorching) accelerating a crosslinking reaction in an extruder readily occurs due to the hygroscopic properties of the color masterbatch pellets. This may cause adverse effects on the quality and shape of the molded product.

For example, as disclosed on pages 2 to 3 in Japanese Patent Laying-Open No. 2000-319464 (PTD 1), carbon black is blended into silane crosslinked polyethylene not for coloring but for molding a semiconductive resin layer of a power cable. FIG. 1 of PTD 1 shows a cross-sectional structure of a power cable of four layers including a soft copper twisted wire conductor, an inner semiconductive layer (crosslinked polyethylene), an insulating coating layer (crosslinked polyethylene), and an outer semiconductive layer (crosslinked polyethylene), which are arranged in this order from the center. According to the invention disclosed in PTD 1, for preventing scorching, in a molding and kneading stage, a silanol condensation catalyst accelerating a crosslinking reaction is not blended into a resin composition forming a semiconductive resin layer made of silane crosslinked polyethylene. Thus, since a silanol condensation catalyst is not blended into the semiconductive resin composition, a crosslinking reaction does not smoothly progress. PTD 1 accordingly discloses that scorching can be completely suppressed even if there is a heating effect within an extruder or an influence of hygroscopic moisture by blending a carbon black. Conversely, since a silanol condensation catalyst is not blended into the semiconductive resin composition, a crosslinking reaction does not smoothly progress even if a crosslinking treatment, for example, a hydrothermal treatment, a steam treatment and the like are carried out after molding. PTD 1 discloses that, in such a case, a part of the silanol condensation catalyst blended into an uncrosslinked polyethylene insulation coating layer extruded and coated in the same process is shifted into the semiconductive resin coating layer, thereby allowing crosslinking to occur.

The method disclosed in PTD 1, however, requires multilayer molding of at least two or more layers including: a silane crosslinked polyethylene layer containing a pigment (carbon black in PTD 1) but not containing a silanol condensation catalyst; and a layer not containing a pigment but containing a silanol condensation catalyst. Thus, it becomes necessary to provide facilities for molding such as an extruder allowing multilayer molding. Accordingly, the manufacturing process becomes complicated, so that productivity is impaired. Also, layered coloring may not be preferable in consideration of coloring. Namely, there has been no method proposed for coloring without causing scorching in the case of silane crosslinked polyethylene into which a silanol condensation catalyst is blended during molding.

Furthermore, Japanese Patent National Publication No. 06-510825 (PTD 2) discloses the invention related to a method for dyeing polymer fiber. According to the method disclosed in PTD 2, polymer fiber is brought into contact with a dye composition containing a disperse dye and a swelling agent, and then, the fiber in contact with the dye composition is heated for a sufficient time period at a temperature at least lower than the melting point of the polymer fiber, to disperse part of the disperse dye into the polymer fiber. According to the method disclosed in PTD 2, however, polymer fiber needs to be heated at a temperature lower than the melting point of this fiber for several minutes while being brought into contact with the dye composition. This leads to a problem of poor productivity.

Furthermore, Japanese Patent Laying-Open No. 63-75192 (PTD 3) discloses a continuous dyeing method for a dyeable polymer that can be melted and extruded, which includes the steps of: extruding melted polymer through an orifice; bringing this extruded polymer into contact with an aqueous dye solution for this polymer while the polymer is in a melted state; and removing the resulting dyed polymer from the aqueous solution. However, PTD 3 discloses a polyethylene blend as a dyeable polymer that can be melted and extruded, but fails to disclose coloring of a silane crosslinked polyethylene resin.

Japanese Patent Laying-Open No. 04-327208 (PTD 4) discloses a method of coloring a polyethylene fiber assembly by a solvent color dissolved in at least one type of organic solvents. However, PTD 4 discloses a method related to coloring of a high-strength ultra-high polymer polyethylene fiber assembly having a viscosity average molecular weight of 500000 or more, but fails to disclose coloring of a silane crosslinked polyethylene resin.

Furthermore, Japanese Patent Laying-Open No. 59-133229 (PTD 5) discloses a method of coat-molding an outer circumference of silane crosslinked polyethylene, which is molded without containing a colorant, using polyolefin containing a colorant. PTD 5 however fails to disclose coloring of a silane crosslinked polyethylene resin itself.

### CITATION LIST

### Patent Document

PTD 1: Japanese Patent Laying-Open No. 2000-319464
PTD 2: Japanese Patent National Publication No. 06-510825
PTD 3: Japanese Patent Laying-Open No. 63-75192
PTD 4: Japanese Patent Laying-Open No. 04-327208
PTD 5: Japanese Patent Laying-Open No. 59-133229

### SUMMARY OF INVENTION

### Technical Problem

The present invention has been made in order to solve the above-described problems. An object of the present invention is to obtain a resin molded product of silane crosslinked polyethylene that is uniformly colored without causing scorching even if a silanol condensation catalyst is blended for molding, and also to sequentially carry out molding and coloring without impairing productivity.

### Solution to Problem

A method of manufacturing a molded product of a silane crosslinked polyethylene resin according to the present invention includes the steps of: melting a silane crosslinked polyethylene resin; extrusion-molding the melted resin; bringing a surface of a molded product obtained by the extrusion molding into contact with an oil-soluble dye solution before at least the surface solidifies; separating the molded product from the oil-soluble dye solution; and cooling the molded product separated from the oil-soluble dye solution.

In the method of manufacturing a molded product of a silane crosslinked polyethylene resin according to the present invention, it is preferable that the step of bringing a surface of a molded product obtained by the extrusion molding into contact with an oil-soluble dye solution before at least the surface solidifies is the step of immersing the molded product in the oil-soluble dye solution.

In the method of manufacturing a molded product of a silane crosslinked polyethylene resin according to the present invention, it is preferable that the step of bringing a surface of a molded product obtained by the extrusion molding into contact with an oil-soluble dye solution before at least the surface solidifies is the step of splaying the oil-soluble dye solution on the molded product.

In the method of manufacturing a molded product of a silane crosslinked polyethylene resin according to the present invention, it is preferable that the step of cooling the molded product separated from the oil-soluble dye solution is the step of water-cooling the molded product.

In the method of manufacturing a molded product of a silane crosslinked polyethylene resin according to the present invention, it is preferable that a solvent used for the oil-soluble dye solution is alcohols or ketones, or a mixture of two or more types thereof.

In the method of manufacturing a molded product of a silane crosslinked polyethylene resin according to the present invention, it is preferable that a silanol condensation catalyst is mixed with the silane crosslinked polyethylene resin in the step of melting a silane crosslinked polyethylene resin.

The present invention also provides a method of manufacturing a rod-shaped molded product of a silane crosslinked polyethylene resin. The method includes the steps of: feeding a core member made of a metal wire rod; melting a silane crosslinked polyethylene resin; extrusion-molding the core member in a rod shape while coating an outer circumference of the core member with the resin; bringing a surface of a molded product obtained by the extrusion molding into contact with an oil-soluble dye solution before at least the surface solidifies; separating the molded product from the oil-soluble dye solution; and cooling the molded product separated from the oil-soluble dye solution.

The present invention further provides a manufacturing apparatus for a rod-shaped molded product of a silane crosslinked polyethylene resin. The manufacturing apparatus includes: a pulling-out unit feeding a core member made of a metal wire rod; a melting unit melting a silane crosslinked polyethylene resin; an extruder extrusion-molding the core member in a rod shape while coating an outer circumference of the core member with the resin; a coloring bath in which a surface of a molded product obtained by the extrusion molding is brought into contact with an oil-soluble dye solution before at least the surface solidifies; and a cooling bath in which the molded product separated from the oil-soluble dye solution is cooled.

In the manufacturing apparatus for a rod-shaped molded product of a silane crosslinked polyethylene resin according to the present invention, it is preferable that a cooling mechanism for the oil-soluble dye solution is provided in the coloring bath in which the surface is brought into contact with the oil-soluble dye solution.

In the manufacturing apparatus for a rod-shaped molded product of a silane crosslinked polyethylene resin according to the present invention, it is preferable that an oil-soluble dye concentration adjustment mechanism for the oil-soluble dye solution is provided in the coloring bath in which the surface is brought into contact with the oil-soluble dye solution.

### Advantageous Effects of Invention

According to the present invention, a colored molded product of a silane crosslinked polyethylene resin can be obtained without causing scorching even by a resin such as a silane crosslinked polyethylene resin that may cause scorching during molding due to moisture. Also, molding and coloring can be sequentially carried out without impairing productivity.

### BRIEF DESCRIPTION OF DRAWINGS

FIG. 1 is a flowchart illustrating a method of manufacturing a molded product of a silane crosslinked polyethylene resin according to the present invention.

FIG. 2 is a diagram conceptually showing a manufacturing apparatus in the case where a manufacturing method according to the first embodiment is carried out.

FIG. 3 is a diagram conceptually showing a manufacturing apparatus in the case where a manufacturing method according to the second embodiment is carried out.

FIG. 4 is a diagram conceptually showing a manufacturing apparatus in the case where a manufacturing method according to the third embodiment is carried out.

FIG. 5 is a diagram conceptually showing a manufacturing apparatus in the case where a manufacturing method according to the fourth embodiment is carried out.

FIG. 6 is a diagram schematically showing a basic structure of a coloring bath 2, a cleaning bath 3 and a water-cooling bath 4.

### DESCRIPTION OF EMBODIMENTS

### Method of Manufacturing Molded Product of Silane Crosslinked Polyethylene Resin

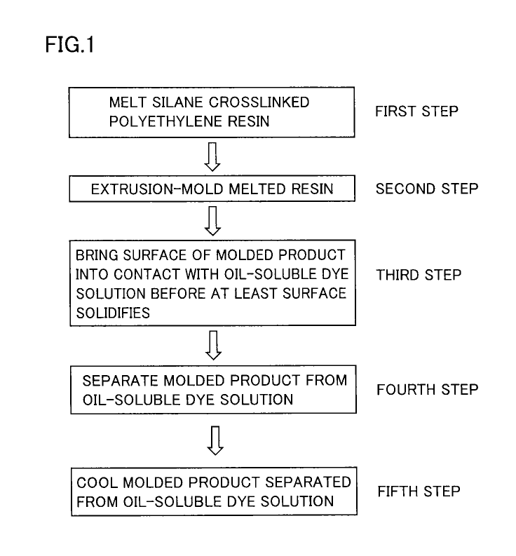

FIG. 1 is a flowchart illustrating a method of manufacturing a molded product of a silane crosslinked polyethylene resin according to the present invention. The method of manufacturing a molded product of a silane crosslinked polyethylene resin according to the present invention includes the steps of: (1) melting a silane crosslinked polyethylene resin (the first step); (2) extrusion-molding the melted resin (the second step); (3) bringing a surface of a molded product obtained by the extrusion molding into contact with an oil-soluble dye solution before at least the surface solidifies (the third step); (4) separating the molded product from the oil-soluble dye solution (the fourth step); and (5) cooling the molded product separated from the oil-soluble dye solution (the fifth step).

In the first step, it is preferable that a silanol condensation catalyst is mixed with the silane crosslinked polyethylene resin. In this case, an uncrosslinked silane crosslinked polyethylene resin means a resin composition in the state where an active silane group is introduced into a polyethylene main chain, each of which does not yet undergo a condensation reaction, that is, not undergo crosslinking. One of the methods for introducing an active silane group into a polyethylene main chain is a method of grafting a vinylsilane compound to a polyethylene main chain in the presence of a radical generator for introduction. In this case, it is desirable that polyethylene obtained by grafting a vinylsilane compound in advance is prepared in a form such as a pellet form, a flake form, powder form or the like so as to be readily molded. Alternatively, a commercially available polyethylene having a vinylsilane compound already grafted thereto can also be employed.

In this case, examples of polyethylene may be high density polyethylene, medium density polyethylene, low density polyethylene, and the like, each of which may be used alone or may be used as a blend of two or more types thereof. In this case, examples of a vinylsilane compound may be vinyl trimethoxysilane, vinyl triethoxysilane, vinyl triacetoxysilane, vinyl dimethoxymethylsilane, vinyl diethoxymethylsilane, vinyl methoxydimethylsilane, vinyl ethoxydimethylsilane, and the like, each of which may be used alone or may be used as a mixture of two or more types thereof.

Furthermore, a radical generator that coexists when a vinylsilane compound is grafted to a polyethylene main chain only has to be a compound that is generally used for a grafting reaction of polyolefin, examples of which may be organic peroxides such as dicumyl peroxide, benzoyl peroxide, di-t-butyl peroxide, and t-butyloxy-2-ethylhexanoate; and azo compounds such as azobisisobutyronitrile and methyl azobisisobutyrate. Each of these may be used alone or may be used as a mixture of two or more types thereof.

Furthermore, an antioxidant, a photostabilizer, a metal harm inhibitor, and the like may be added as required though not indispensable to the present invention.

For example, an antioxidant may be: a monophenol series such as 2,4-dimethyl-6-t-butylphenol, 2,6-di-t-butylphenol, 2,6-di-t-butyl-p-cresol, tetrakis[methylene-3-(3′,5′-di-t-butyl-4′-hydroxyphenyl)propionate]methane, 2,6-di-t-butyl-4-ethylphenol, 2,4,6-tri-t-butylphenol, 2,5-di-t-butylhydroquinone, butylated hydroxyanisole, n-octadecyl-3-(3′,5′-di-t-butyl-4′-hydroxyphenyl)propionate, and stearyl-β-(3,5-di-t-butyl-4-hydroxyphenyl)propionate; a bisphenol series such as 4,4′-dihydroxydiphenyl, 2,2′-methylenebis(4-methyl-6-t-butylphenol), 2,2′-methylenebis(4-ethyl-6-t-butylphenol), 4,4′-methylenebis(2,6-di-t-butylphenol), 4,4′-butylidenebis(3-methyl-6-t-butylphenol), and 2,6-bis(2′-hydroxy-3′-t-butyl-5′-methylbenzyl)-4-methylphenol; a tri- or more polyphenol series such as 1,1,3-tris(2′-methyl-4′-hydroxy-5′-t-butylphenyl)butane, 1,3,5-trimethyl-2,4,6-tris(3′,5′-di-t-butyl-4′-hydroxybenzyl)benzene, tris(3,5-di-t-butyl-4-hydroxyphenyl)isocyanurate, tris[β-(3,5-di-t-butyl-4-hydroxyphenyl)propionyloxy ethyl]isocyanurate, tetrakis[methylene-3-(3′,5′-di-t-butyl-4′-hydroxyphenyl)propionate]methane; a thiobisphenol series such as 2,2′-thiobis(4-methyl-6-t-butylphenol), 4,4′-thiobis(2-methyl-6-t-butylphenol), and 4,4′-thiobis(3-methyl-6-t-butylphenol); a naphthylamine series such as aldol-α-naphthylamine, phenyl-α-naphthylamine, and phenyl-β-naphthylamine; diphenylamine series such as p-isopropoxy diphenylamine; a phenylenediamine series such as N,N′-diphenyl-p-phenylenediamine, N,N′-di-β-naphthyl-p-phenylenediamine, N-cyclohexyl-N′-phenyl-p-phenylenediamine, and N-isopropyl-N′-phenyl-p-phenylenediamine. Among others, a monophenol series, a bisphenol series, a tri- or more polyphenol series, a thiobisphenol series, and the like may be employed. Each of these may be used alone or may be used as a mixture of two or more types thereof.

A photostabilizer may be: dimethyl succinate.1-(2 hydroxyethyl)-4-hydroxy-2,2,6,6-tetramethyl-4-piperidine polycondensate, 4-t-butylphenyl salicylate, 2,4-dihydroxybenzophenone, 2,2′-dihydroxy-4-methoxy benzophenone, ethyl-2-cyano-3,3′-diphenyl acrylate, 2-ethylhexyl-2-cyano-3,3′-diphenyl acrylate, 2-(2′-hydroxy-3′-t-butyl-5′-methylphenyl)-5-chlorobenzotriazol, 2-(2′-hydroxy-3,5′-di-t-butylphenyl)benzotriazol, 2-(2′-hydroxy-5′-methylphenyl)benzotriazol, 2-hydroxy-5-chloro benzophenone, 2-hydroxy-4-methoxy benzophenone-2-hydroxy-4-octoxy benzophenone, 2-(2′-hydroxy-4-octoxyphenyl)benzotriazol, monoglycol salicylate, oxalic acid amide, phenyl salicylate, 2,2′,4,4′-tetrahydroxybenzophenone, and the like, each of which may be used alone or may be used as a mixture of two or more types thereof.

A metal harm inhibitor may be a hydrazide derivative, an oxalic acid derivative, a salicylic acid derivative, and the like. A hydrazide derivative metal harm inhibitor may be 1,2-bis[3-(4-hydroxy-3,5-di-tert-butylphenyl)propionyl]hydrazine, N,N′-diacetyladipic acid hydrazide, adipic acid bis(α-phenoxy propionyl hydrazide), terephthalic acid bis(α-phenoxy propionyl hydrazide), sebacic acid bis(a-phenoxy propionyl hydrazide), isophthalic acid bis(β-phenoxy propionyl hydrazide), and the like.

An oxalic acid derivative metal harm inhibitor may be N,N′-dibenzoyl(oxalyl dihydrazide), N-benzal-(oxalyl dihydrazide), oxalyl bis-4-methylbenzylidene hydrazide, oxalyl bis-3-ethoxybenzylidene hydrazide, and the like. A salicylic acid derivative metal harm inhibitor may be 3-(N-salicyloyl)amino-1,2,4-triazole, decamethylenedicarboxylic acid disalicyloyl hydrazide, and the like, each of which may be used alone or may be used as a mixture of two or more types thereof.

A silanol condensation catalyst may be metal salt of a carboxylic acid, an organic base, metal salt of an inorganic acid or an organic acid, and the like.

Metal of metal salt of a carboxylic acid mentioned above may be tin, zinc, iron, lead, cobalt, and the like. Metal salt of a carboxylic acid may specifically be dioctyltin dilaurate, dibutyltin dilaurate, dibutyltin diacetate, dibutyltin dioctoate, stannous acetate, stannous octanoate, zinc octanoate, lead naphthenate, cobalt naphthenate, and the like.

Furthermore, an organic base may specifically be ethylamine, dibutyl amine, hexylamine, pyridine, and the like.

Furthermore, an inorganic acid may specifically be sulfuric acid, hydrochloric acid, and the like.

Furthermore, an organic acid may specifically be toluenesulfonic acid, acetic acid, stearic acid, maleic acid, and the like.

As a method of blending a silanol condensation catalyst with uncrosslinked silane crosslinked polyethylene, for example, a silanol condensation catalyst masterbatch is produced using polyethylene or a resin compatible with polyethylene, and prepared in a form such as a pellet form, a flake form, powder form or the like so as to be readily molded, and then, dry-blended with uncrosslinked silane crosslinked polyethylene in a pellet form, a flake form, powder form or the like mentioned above. Alternatively, a commercially available masterbatch having a silanol condensation catalyst already condensed therein can also be used.

According to the manufacturing method of the present invention, as shown in FIG. 1, a silane crosslinked polyethylene resin is melted in the first step. In this first step, the silane crosslinked polyethylene resin is heated to a temperature equal to or higher than the melting point thereof and thereby melted.

In the subsequent second step, the melted resin is extrusion-molded. The silane crosslinked polyethylene resin that has been melted at the temperature equal to or higher than the melting point as described above is extrusion-molded with an extruder. Thus, a resin molded product before coloring is obtained through these steps.

Furthermore, according to the manufacturing method of the present invention, as shown in FIG. 1, in the third step, the surface of the molded product obtained by extrusion molding in the second step is brought into contact with an oil-soluble dye solution before at least the surface solidifies. The resin molded product has a temperature equal to or higher than the melting point of the resin immediately after the second step, during which the third step is carried out.

The reason why it is preferable to bring the surface of the molded product into contact with the oil-soluble dye solution at a temperature equal to or higher than the melting point of the resin is as follows. Specifically, in the case of coloring using a dye, a resin is colored by incorporating dye molecules between the molecules of the targeted resin. However, since a polyethylene resin is a crystalline material, polyethylene molecules are crystallized at the temperature equal to or lower than its melting point. Thus, even if a polyethylene resin is brought into contact with a dye, dye molecules are less likely to be diffused through polyethylene molecules, so that coloring takes much time. On the other hand, the crystal of polyethylene resin dissolves at the temperature equal to or higher than its melting point, thereby significantly increasing the rate of the dye molecules diffusing through polyethylene molecules. Consequently, coloring can be done in a very short time.

The oil-soluble dye solution used in the third step is obtained by dissolving an oil-soluble dye in an organic solvent. Examples of such an oil-soluble dye may be solvent black 3, solvent black 5, solvent black 7, solvent black 27, solvent black 29, solvent black 34, solvent black 45, solvent blue 4, solvent blue 5, solvent blue 35, solvent blue 36, solvent blue 38, solvent blue 45, solvent blue 59, solvent blue 63, solvent blue 68, solvent blue 70, solvent blue 78, solvent blue 87, solvent blue 94, solvent blue 97, solvent blue 101, solvent blue 102, solvent blue 104, solvent blue 122, solvent brown 53, solvent green 3, solvent green 5, solvent green 7, solvent green 20, solvent green 28, solvent orange 3, solvent orange 14, solvent orange 54, solvent orange 60, solvent orange 62, solvent orange 63, solvent orange 86, solvent orange 107, solvent red 3, solvent red 8, solvent red 18, solvent red 23, solvent red 24, solvent red 25, solvent red 27, solvent red 49, solvent red 52, solvent red 109, solvent red 111, solvent red 119, solvent red 122, solvent red 124, solvent red 135, solvent red 146, solvent red 149, solvent red 150, solvent red 168, solvent red 169, solvent red 172, solvent red 179, solvent red 195, solvent red 196, solvent red 197, solvent red 207, solvent red 222, solvent red 227, solvent red 312, solvent red 313, solvent violet 8, solvent violet 9, solvent violet 11, solvent violet 13, solvent violet 14, solvent violet 26, solvent violet 28, solvent violet 31, solvent violet 36, solvent violet 59, solvent yellow 2, solvent yellow 14, solvent yellow 16, solvent yellow 21, solvent yellow 33, solvent yellow 43, solvent yellow 44, solvent yellow 54, solvent yellow 56, solvent yellow 82, solvent yellow 85, solvent yellow 93, solvent yellow 98, solvent yellow 104, solvent yellow 114, solvent yellow 131, solvent yellow 135, solvent yellow 157, solvent yellow 160, solvent yellow 163, solvent yellow 167, solvent yellow 176, solvent yellow 179, solvent yellow 185, solvent yellow 189, or may be a compound produced based thereon. Each of these elements may be used alone or may be used as a mixture of two or more types thereof, but only has to be selected in accordance with the targeted color.

Examples of an organic solvent for dissolving an oil-soluble dye may be ethanol, 1-propanol, 2-propanol, 1-butanol, normal hexane, normal butanol, acetone, cyclohexane, xylene, toluene, ethyl acetate, butyl acetate, methyl ethyl ketone, benzene, diethyl ether, chloroform, methylene chloride, dichloromethane, and the like, each of which may be used alone or may be used as a mixture of two or more types thereof. Furthermore, since the solubility in each organic solvent differs depending on the oil-soluble dye to be dissolved, it is preferable that the organic solvent is selected appropriately in accordance with the oil-soluble dye to be dissolved.

Among others, it is particularly preferable that an organic solvent used for dissolving an oil-soluble dye is selected from alcohols such as ethanol, 1-propanol, 2-propanol, and 1-butanol; and Ketones such as methyl ethyl ketone, each of which may be used alone or may be used as a mixture of two or more types thereof. On the other hand, aliphatic hydrocarbons such as normal hexane; aromatic hydrocarbons such as xylene, toluene cyclohexane, and benzene; esters such as ethyl acetate and butyl acetate may swell, dissolve and corrode polyethylene, and therefore, preferably not used in the present method as long as there are no other reasons that these elements should be used.

According to the manufacturing method of the present invention, as shown in FIG. 1, in the fourth step, the oil-soluble dye solution is separated from the molded product having been brought into contact with the oil-soluble dye solution in the third step. Although the method of separating the oil-soluble dye solution from the molded product is not particularly limited, for example, there may be a method of causing the molded product to pass through a cleaning bath containing water as described later.

According to the manufacturing method of the present invention, as shown in FIG. 1, in the fifth step, the molded product from which the oil-soluble dye solution has been separated is cooled. For example, generally-used methods such as a water-cooling method and an air-cooling method may be used for cooling the molded product from which the oil-soluble dye solution has been separated, but the step of water-cooling the molded product is preferable. Furthermore, in the case where the resin molded product is formed in a sheet shape, a cooling roll may be used for cooling and solidification.

The molded product of a silane crosslinked polyethylene resin that is colored by the manufacturing method of the present invention in this way has already been blended with a silanol condensation catalyst. Accordingly, when this molded product is subjected to a hydrothermal treatment or a steam treatment after molding, it can readily be caused to undergo a crosslinking reaction.

According to the manufacturing method of the present invention described above, even in the case where a silanol condensation catalyst is blended for molding, it becomes possible to obtain a molded product formed of a colored silane crosslinked polyethylene resin without causing scorching, and also possible to sequentially carry out molding and coloring without impairing productivity.

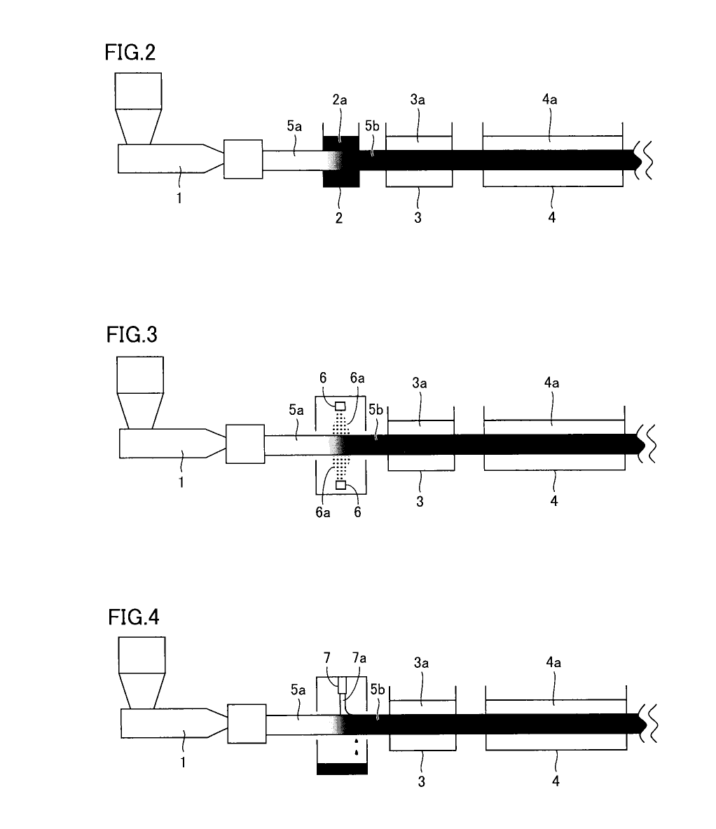

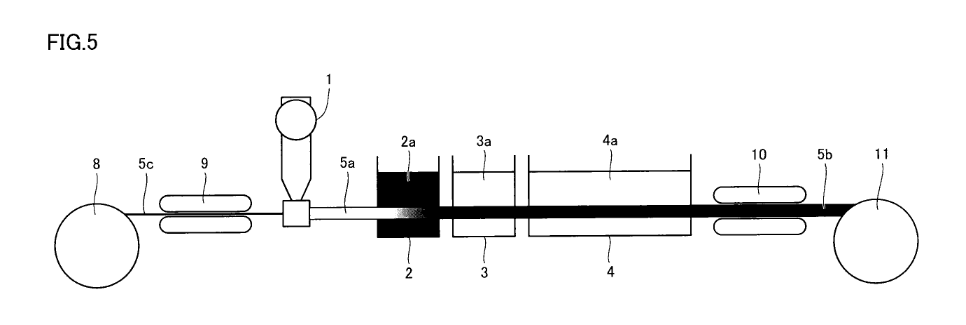

Hereinafter described will be a manufacturing apparatus by which a method of manufacturing a molded product of a silane crosslinked polyethylene resin of the present invention described above can be suitably implemented, as well as a manufacturing method of the present invention of each embodiment. FIG. 2 is a diagram conceptually showing a manufacturing apparatus in the case where a manufacturing method according to the first embodiment is carried out. FIG. 3 is a diagram conceptually showing a manufacturing apparatus in the case where a manufacturing method according to the second embodiment is carried out. FIG. 4 is a diagram conceptually showing a manufacturing apparatus in the case where a manufacturing method according to the third embodiment is carried out. FIG. 5 is a diagram conceptually showing a manufacturing apparatus in the case where a manufacturing method according to the fourth embodiment is carried out. Hereinafter sequentially described will be a manufacturing apparatus used in the case where the manufacturing method according to each embodiment is carried out. It is to be noted that a resin forming a resin molded product, an oil-soluble dye solution and the like that are considered as preferable are as explained above in the description of the manufacturing method of the present invention, and therefore, description thereof will not be hereinafter repeated.

### First Embodiment

FIG. 2 shows a manufacturing apparatus in the case where the manufacturing method according to the first embodiment is carried out, which illustrates an example in which an extruder 1, a bath (coloring bath) 2 filled with an oil-soluble dye solution 2a and a water-cooling bath 4 are arranged in this order along the direction of the flow of the resin molding process.

Extruder 1 used in the manufacturing apparatus in the example shown in FIG. 2 is not particularly limited in its specifications, screw shape, molding conditions, die shape and the like as long as a resin molded product having intended shape and quality can be achieved. This extruder 1 is employed to suitably perform the first and second steps in the manufacturing method of the present invention described above.

In the example shown in FIG. 2, a rod-shaped resin molded product obtained from extruder 1 is immersed in oil-soluble dye solution 2a within coloring bath 2 in the state where this molded product is kept at a temperature equal to or higher than the melting point of the resin. Thereby, the third step in the manufacturing method of the present invention described above is suitably carried out. In this case, the time period during which the resin molded product is immersed in oil-soluble dye solution 2a is not particularly limited, but may be set in accordance with the desired color. For example, sufficient coloring can be achieved even if the immersing time period is very short, for example, 1 second or less. Furthermore, the cross-sectional shape of the rod-shaped resin molded product is not particularly limited, but may be circular (perfectly circular, elliptical), or may be rectangular or polygonal.

Furthermore, coloring bath 2 may be provided with a cooling mechanism for oil-soluble dye solution 2a as required. This is because oil-soluble dye solution 2a is continuously in contact with resin molded product 5a before coloring having a temperature equal to or higher than the melting point of this solution 2a, and therefore, increased in temperature spontaneously by long-time molding and coloring. Oil-soluble dye solution 2a contains an organic solvent. Accordingly, when the temperature rises, the volatilization rate also rises, with the result that the oil-soluble dye concentration may be changed from that in the initial state. Also, for the reasons described above, it is more preferable that the temperature of oil-soluble dye solution 2a is kept at a temperature lower, by 50° C. or higher, than the boiling point of the solvent used for the oil-soluble dye solution, or than the boiling point of a solvent having the lowest boiling point among two or more types of solvents forming a mixture.

Furthermore, coloring bath 2 may be provided with a concentration adjustment mechanism for the oil-soluble dye of oil-soluble dye solution 2a as required. One of the reasons thereof is that the concentration may change by volatilization of the organic solvent in the oil-soluble dye solution as described above. Another reason is that long-time molding and coloring causes the oil-soluble dye element to be diffused into the molded product and thereby lost, so that the concentration may decrease.

In the example shown in FIG. 2, a cleaning bath 3 filled with cleaning water 3a and used for cleaning the oil-soluble dye is provided between coloring bath 2 and water-cooling bath 4. Since such a cleaning bath 3 is arranged between coloring bath 2 and water-cooling bath 4, oil-soluble dye solution 2a adhering to colored resin molded product 5b is separated, so that oil-soluble dye solution 2a can be prevented from polluting water-cooling bath 4 and water 4a. In the example shown in FIG. 2, the fourth step in the manufacturing method of the present invention described above is suitably carried out by means of cleaning bath 3. In addition, as long as the oil-soluble dye solution can be separated from the molded product, any component other than cleaning bath 3 may be employed, in which case an air wiper type or the like can also be alternatively employed.

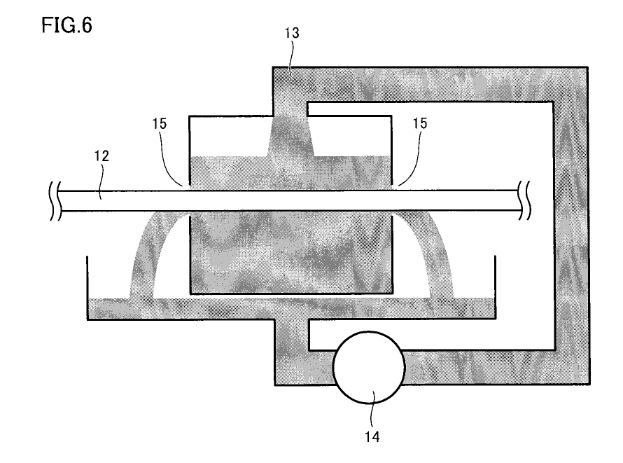

For example, the structure as shown in FIG. 6 is employed as a basic structure of coloring bath 2, cleaning bath 3 and water-cooling bath 4. The example shown in FIG. 6 represents a configuration in which molded product 12 is introduced from a hole 15 provided in a bath (coloring bath 2, cleaning bath 3 or water-cooling bath 4) containing liquid (an oil-soluble dye solution or water) 13, passed through the bath, brought into contact with liquid 13, and then, exits through another hole 15 out of the bath. Furthermore, the example shown in FIG. 6 represents a configuration in which liquid 13 within the bath is set such that its liquid level is located higher than the position of hole 15, and liquid 13 leaked through hole 15 out of the bath is circulated back into the bath by a pump 14. By providing such a structure, molded product 12 and targeted liquid 13 can be continuously brought into contact with each other.

In the example shown in FIG. 2, colored resin molded product 5b that has been passed through cleaning bath 3 and separated from the oil-soluble dye solution is caused to pass through water 4a in water-cooling bath 4, and thereby cooled and solidified. In the example shown in FIG. 2, the fifth step in the manufacturing method of the present invention described above is suitably carried out by means of water-cooling bath 4. Although FIG. 2 shows an example using water-cooling bath 4, an air-cooling method or a cooling roll may be used as described above. Furthermore, the rod-shaped resin molded product after solidification may for example be hard and not readily deformed at ordinary temperature like a plastic pole, or may be flexibly deformed even at ordinary temperature like a coating used for a power cord.

### Second Embodiment

FIG. 3 shows a manufacturing apparatus in the case where the manufacturing method according to the second embodiment is carried out, which illustrates an example in which extruder 1, a device for spraying an oil-soluble dye solution on the resin molded product in an atomized manner (a liquid colorant spray device) 6 and water-cooling bath 4 are arranged in this order along the direction of the flow of the resin molding process. In this case, the oil-soluble dye solution is obtained by dissolving an oil-soluble dye in an organic solvent. In addition, each component having a configuration similar to that of the manufacturing apparatus used when performing the manufacturing method according to the first embodiment shown in FIG. 2 is designated by the same reference characters, and description thereof will not be repeated.

The manufacturing apparatus of the example shown in FIG. 3 is different from the manufacturing apparatus of the example shown in FIG. 2 only in the point that liquid colorant spray device 6 is used in place of coloring bath 2 when performing the third step in the manufacturing method of the present invention described above. According to the manufacturing apparatus of the example shown in FIG. 3, in the state where resin molded product 5a before coloring that is obtained from extruder 1 is kept at a temperature equal to or higher than the melting point of the resin, an oil-soluble dye solution 6a is sprayed in an atomized manner by liquid colorant spray device 6 to form a colored resin molded product 5b. Also by using such a manufacturing apparatus, the manufacturing method of the present invention described above can be suitably carried out.

### Third Embodiment

FIG. 4 shows a manufacturing apparatus used when performing the manufacturing method according to the third embodiment, which illustrates an example in which extruder 1, a device for dripping an oil-soluble dye solution onto the resin molded product (a liquid colorant dripping device) 7 and water-cooling bath 4 are arranged in this order along the direction of the flow of the resin molding process. In this case, the oil-soluble dye solution is obtained by dissolving an oil-soluble dye in an organic solvent. In addition, each component having a configuration similar to that of the manufacturing apparatus used when performing the manufacturing method according to the first embodiment shown in FIG. 2 is designated by the same reference characters, and description thereof will not be repeated.

The manufacturing apparatus of the example shown in FIG. 4 is different from the manufacturing apparatus of the example shown in FIG. 2 only in the point that liquid colorant dripping device 7 is used in place of coloring bath 2 when performing the third step in the manufacturing method of the present invention described above. According to the manufacturing apparatus of the example shown in FIG. 4, in the state where resin molded product 5a before coloring that is obtained from extruder 1 is kept at a temperature equal to or higher than the melting point of the resin, an oil-soluble dye solution 7a is dripped by liquid colorant dripping device 7 to form a colored resin molded product 5b. Also by using such a manufacturing apparatus, the manufacturing method of the present invention described above can be suitably carried out.

### Fourth Embodiment

FIG. 5 shows a manufacturing apparatus used when performing the manufacturing method according to the fourth embodiment. According to this manufacturing apparatus, a core member 5c is fed while being pulled out using a pulling-out unit 9 from a roll (an unreeling unit) 8 having core member 5c wound therearound at the rear portion of extruder 1, and then introduced into a die head portion of extruder 1, in which the outer circumference of core member 5c is coated with an extrusion-molded resin, thereby forming a rod-shaped and resin-coated molded product having an outer circumference coated with a colored resin (a rod-shaped molded product). FIG. 5 illustrates an example in which extruder 1, a bath (coloring bath) 2 filled with oil-soluble dye solution 2a and water-cooling bath 4 are arranged in this order along the direction of the flow of the molding process. The resin-coated molded product having passed through water-cooling bath 4 is pulled by a pulling-in unit 10, and reeled by a roll (pulling-out unit) 11.

The present invention also aims to provide such a manufacturing apparatus for a rod-shaped molded product of a silane crosslinked polyethylene resin. Specifically, the manufacturing apparatus for a rod-shaped molded product of a silane crosslinked polyethylene resin according to the present invention includes: a pulling-out unit that feeds a core member made of a metal wire rod; a melting unit that melts a silane crosslinked polyethylene resin; an extruder that extrusion-molds the core member in a rod shape while coating an outer circumference of the core member with the resin; a coloring bath in which a surface of a molded product obtained by extrusion molding is brought into contact with an oil-soluble dye solution before at least this surface solidifies; and a cooling bath in which the molded product separated from the oil-soluble dye solution is cooled. Furthermore, the present invention also provides a method of manufacturing a rod-shaped molded product of a silane crosslinked polyethylene resin, which includes the steps of: feeding a core member made of a metal wire rod; melting a silane crosslinked polyethylene resin (corresponding to the first step described above); extrusion-molding the core member in a rod shape while coating an outer circumference of the core member with the resin (corresponding to the second step described above); bringing a surface of a molded product obtained by the extrusion molding into contact with an oil-soluble dye solution before at least the surface solidifies (corresponding to the third step described above); separating the molded product from the oil-soluble dye solution (corresponding to the fourth step described above); and cooling the molded product separated from the oil-soluble dye solution (corresponding to the fifth step described above). The method of manufacturing a rod-shaped molded product of a silane crosslinked polyethylene resin according to the present invention as described above can be suitably carried out using the manufacturing apparatus for a rod-shaped molded product of a silane crosslinked polyethylene resin of the present invention.

Also, extruder 1 shown by way of example in FIG. 5 and used in the manufacturing apparatus for a rod-shaped molded product of a silane crosslinked polyethylene resin of the present invention is not particularly limited in its specifications, screw shape, molding conditions, die shape, and the like as long as a resin-coated molded product (rod-shaped molded product) having an intended shape, coating thickness and quality can be achieved. This extruder 1 is used to suitably carry out the steps of: melting a silane crosslinked polyethylene resin; and extrusion-molding a core member in a rod shape while coating an outer circumference of the core member with the resin, each step being included in the method of manufacturing a rod-shaped molded product of a silane crosslinked polyethylene resin according to the present invention described above.

Examples of core member 5c of the resin-coated molded product may be a linear member or a twisted wire member made of copper or steel, which may be used as a single member or may be used as a bundle obtained by twisting these members. Furthermore, the rod-shaped resin-coated molded product obtained by coating each core member 5c with a resin by the method of the present invention may be freely flexible or may be not freely flexible but may be highly rigid. Furthermore, the cross-sectional shape of the rod-shaped resin-coated molded product is not particularly limited, but may be circular, elliptical, rectangular, or polygonal.

In the example shown in FIG. 5, the resin-coated molded product obtained from extruder 1 is immersed in oil-soluble dye solution 2a within coloring bath 2 in the state where this molded product is maintained at a temperature equal to or higher than the melting point of the resin. Thereby, it becomes possible to suitably perform the step of bringing a surface of a molded product obtained by extrusion molding into contact with an oil-soluble dye solution before at least this surface solidifies, according to the method of manufacturing a rod-shaped molded product of a silane crosslinked polyethylene resin of the present invention as described above. In this case, the time period during which the resin-coated molded product is immersed in oil-soluble dye solution 2a is not particularly limited, but may be set in accordance with the desired color. For example, sufficient coloring can be achieved even if the immersing time period is very short, for example, 1 second or less. In addition, also in the case of the manufacturing apparatus as shown in FIG. 5, for the reason similar to that described above in the example of FIG. 2, coloring bath 2 may be provided with a cooling mechanism for oil-soluble dye solution 2a and a concentration adjustment mechanism for an oil-soluble dye, as required.

Also in the example shown in FIG. 5, cleaning bath 3 for cleaning the oil-soluble dye containing cleaning water 3a is provided between coloring bath 2 and water-cooling bath 4. Since such a cleaning bath 3 is arranged between coloring bath 2 and water-cooling bath 4, oil-soluble dye solution 2a adhering to colored resin-coated molded product 5b can be prevented from polluting water-cooling bath 4 and water 4a. In the example shown in FIG. 5, the step of separating the molded product from the oil-soluble dye solution in the method of manufacturing a rod-shaped molded product of a silane crosslinked polyethylene resin of the present invention described above is suitably carried out by means of cleaning bath 3. In addition, in the manufacturing apparatus for a rod-shaped molded product of a silane crosslinked polyethylene resin of the present invention, it is not indispensable to provide the means like cleaning bath 3 for separating the oil-soluble dye solution from the molded product, but it is preferable to provide such means in consideration that the method of manufacturing a rod-shaped molded product of a silane crosslinked polyethylene resin of the present invention described above can be suitably carried out. Also, as long as the oil-soluble dye solution can be separated from the molded product, the above-described means does not necessarily have to be cleaning bath 3 but may alternatively be an air wiper type and the like.

In the example shown in FIG. 5, colored resin-coated molded product 5b having passed through cleaning bath 3 and having been separated from the oil-soluble dye solution is caused to pass through water 4a in water-cooling bath 4, and thereby cooled and solidified. In the example shown in FIG. 5, the step of cooling the molded product separated from the oil-soluble dye solution according to the method of manufacturing a rod-shaped molded product of a silane crosslinked polyethylene resin of the present invention described above is suitably carried out by means of water-cooling bath 4. It is to be noted that FIG. 5 shows an example using water-cooling bath 4, but the air-cooling method may be used as described above.

Although the present invention will be hereinafter described in further detail with reference to Examples and Comparative Examples, the present invention is not limited thereto.

(Used Material)

The materials used in Examples and Comparative Examples are as described below. It is to be noted that the following merely shows specific examples, but the invention is not limited to the materials described below.

A: high density polyethylene,

B: vinyl trimethoxysilane,

C: dicumyl peroxide,

D: tetrakis[methylene-3-(3′,5′-di-t-butyl-4′-hydroxyphenyl)propionate]methane,

E: dimethyl succinate.1-(2 hydroxyethyl)-4-hydroxy-2,2,6,6-tetramethyl-4-piperidine polycondensate,

F: 1,2-bis[3-(4-hydroxy-3,5-di-tert-butylphenyl)propionyl]hydrazine,

G: dioctyltin dilaurate,

H: solvent black 3,

I: methyl ethyl ketone.

Furthermore, an uncrosslinked silane crosslinked polyethylene resin obtained by mixing, heat-kneading and pelletizing the above-mentioned A, B and C in a weight ratio of A:B:C=100:2:0.04 was used unless otherwise specified. Furthermore, a silanol condensation catalyst masterbatch obtained by mixing, heat-kneading and pelletizing A, D, E, F, and G in a weight ratio of A:D:E:F:G=100:1:7:2:20 was used unless otherwise specified. The oil-soluble dye solution obtained by mixing H and I in a ratio of H:I=10:100 was used. Furthermore, for molding, an extruder having a single-axis full flight screw φ65 was used and the die head temperature was set at 210° C. to obtain a molded product having a round bar shape of φ3 mm or a resin-coated molded product having a round bar shape of φ5 mm. Furthermore, the obtained molded product or resin-coated molded product was subjected to a hydrothermal treatment (95° C.) for 5 hours as a crosslinking treatment.

(Evaluation Method)

The degree of crosslinking (gel fraction) of the silane crosslinked polyethylene resin obtained in each of Examples 1 to 4 and Comparative Examples 1, 2, 3, and 4 described later was measured based on ISO 10147-1994. Furthermore, the degree of scorching was evaluated based on the number of occurrences of scorching per 1000 m of the molded product.

### Example 1

The manufacturing method according to the first embodiment of the present invention was carried out using the manufacturing apparatus of the example shown in FIG. 2. After uncrosslinked silane crosslinked polyethylene pellets and silanol condensation catalyst masterbatch pellets were dry-blended in a weight ratio of 100:5, the resin was melted (the first step) and subjected to extrusion molding (the second step). After the resin molded product before coloring was removed from the extruder die, it was caused to pass through coloring bath 2 filled with an oil-soluble dye solution and brought into contact with the oil-soluble dye solution (the third step); caused to pass through cleaning bath 3 filled with water (the fourth step); caused to pass through water-cooling bath 4 filled with water and thereby cooled and solidified (the fifth step); and then, reeled by a roll.

At this time, the temperature of the molded product immediately before it was caused to pass through coloring bath 2 was measured by a noncontact thermometer, the result of which was 200±3° C. Furthermore, the time period during which the molded product was in contact with the oil-soluble dye in coloring bath 2 was calculated by the following formula:

[Line direction length of coloring bath (m)]÷[molded product line rate (m/sec)]

The result of this calculation was 1.7 seconds. In this way, a molded product of a silane crosslinked polyethylene resin in Example 1 was obtained.

### Example 2

The manufacturing method according to the second embodiment of the present invention was carried out using the manufacturing apparatus of the example shown in FIG. 3. According to the manufacturing apparatus of the example shown in FIG. 3, a molded product of a silane crosslinked polyethylene resin of Example 2 was obtained in a manner similar to that in Example 1, except that liquid colorant spray device 6 for spraying an oil-soluble dye solution in an atomized manner was used in place of the coloring bath filled with the oil-soluble dye solution, and the resin molded product was brought into contact with oil-soluble dye solution 6a sprayed in an atomized manner from two directions of the resin molded product, that is, from above and below the resin molded product (different in phase by 180° from each other).

### Example 3

The manufacturing method according to the third embodiment of the present invention was carried out using the manufacturing apparatus of the example shown in FIG. 4. According to the manufacturing apparatus of the example shown in FIG. 4, a molded product of a silane crosslinked polyethylene resin of Example 3 was obtained in a manner similar to that in Example 1, except that liquid colorant dripping device 7 for dripping oil-soluble dye solution 7a was used in place of the coloring bath filled with an oil-soluble dye solution, to drip oil-soluble dye solution 7a from above the molded product, thereby bringing the molded product and the oil-soluble dye into contact with each other.

### Example 4

The method of manufacturing a rod-shaped molded product of a silane crosslinked polyethylene resin of the present invention was carried out using the manufacturing apparatus for a rod-shaped molded product of a silane crosslinked polyethylene resin of the present invention shown in FIG. 5. A steel twisted wire of φ3 mm obtained by twisting seven steel linear wires was used as core member 5c. Uncrosslinked silane crosslinked polyethylene pellets and silanol condensation catalyst masterbatch pellets were dry-blended in a weight ratio of 100:5. Then, the outer circumference of core member 5c was coated in a melted state by extrusion molding, thereby obtaining a rod-shaped resin-coated molded product (rod-shaped molded product) of φ5 mm having a circular cross section and having about 1 mm of coating thickness of the resin on the outer circumference of the core member. After the resin-coated molded product before coloring was removed from the extruder die, it was caused to pass through coloring bath 2 filled with an oil-soluble dye solution and brought into contact with the oil-soluble dye solution; caused to pass through cleaning bath 3 filled with water; caused to pass through water-cooling bath 4 filled with water and thereby cooled and solidified; and then reeled by the roll.

At this time, the temperature of the resin-coated molded product immediately before it was caused to pass through coloring bath 2 was measured by a noncontact thermometer, the result of which was 200±3° C. Furthermore, the time period during which the molded product was in contact with the oil-soluble dye in coloring bath 2 was calculated by the following formula:

[Line direction length of coloring bath (m)]÷[molded product line rate (m/sec)]

The result of this calculation was 1.7 seconds. In this way, a rod-shaped molded product of a silane crosslinked polyethylene resin in Example 4 was obtained.

### Comparative Example 1

Uncrosslinked silane crosslinked polyethylene, a silanol condensation catalyst masterbatch and a carbon black concentration color masterbatch were dry-blended in a weight ratio of 100:5:1 and then subjected to extrusion molding. After the molded product was removed from the extruder die, it was caused to pass through the water-cooling bath filled with water and thereby cooled and solidified, and then, reeled by the roll. In this way, a resin molded product of Comparative Example 1 was obtained.

### Comparative Example 2

Uncrosslinked silane crosslinked polyethylene and a carbon black concentration color masterbatch were dry-blended in a weight ratio of 100:1 and subjected to extrusion molding. After the resin molded product was removed from the extruder die, it was caused to pass through the water-cooling bath filled with water and thereby cooled and solidified, and then, reeled by the roll. In this way, a resin molded product of Comparative Example 2 was obtained.

### Comparative Example 3

A resin molded product of Comparative Example 3 was obtained in a manner similar to that in Comparative Example 1, except that a solvent black 3 concentration color masterbatch was used in place of a carbon black concentration masterbatch.

### Comparative Example 4

A resin molded product of Comparative Example 4 was obtained in a manner similar to that in Comparative Example 2, except that a solvent black 3 concentration color masterbatch was used in place of a carbon black concentration masterbatch.

### Comparative Example 5

A steel twisted wire of φ3 mm obtained by twisting seven linear steel wires was used as core member 5c. Uncrosslinked silane crosslinked polyethylene pellets, silanol condensation catalyst masterbatch pellets and a carbon black concentration masterbatch were dry-blended in a weight ratio of 100:5:1. Then, the outer circumference of core member 5c was coated in a melted state by extrusion molding, thereby obtaining a rod-shaped, coated molded product of φ5 mm having a circular cross section and having about 1 mm of coating thickness of the resin on the outer circumference of the core member. After the coated molded product was removed from the extruder die, it was caused to pass through the water-cooling bath filled with water and thereby cooled and solidified, and then, reeled by the roll. In this way, a resin-coated molded product of Comparative Example 5 was obtained.

### Comparative Example 6

A steel twisted wire of φ3 mm obtained by twisting seven linear steel wires was used as core member 5c. Then, uncrosslinked silane crosslinked polyethylene pellets and a carbon black concentration masterbatch were dry-blended in a weight ratio of 100:1. Then, the outer circumference of core member 5c was coated in a melted state by extrusion molding, thereby obtaining a rod-shaped, coated molded product of φ5 mm having a circular cross section and having about 1 mm of coating thickness of the resin on the outer circumference of the core member. After the coated molded product was removed from the extruder die, it was caused to pass through the water-cooling bath filled with water and thereby cooled and solidified, and then, reeled by the roll. In this way, a resin-coated molded product of Comparative Example 6 was obtained.

### Comparative Example 7

A resin-coated molded product of Comparative Example 7 was obtained in a manner similar to that in Comparative Example 5, except that a solvent black 3 concentration color masterbatch was used in place of a carbon black concentration masterbatch.

### Comparative Example 8

A resin-coated molded product of Comparative Example 8 was obtained in a manner similar to that in Comparative Example 6, except that a solvent black 3 concentration color masterbatch was used in place of a carbon black concentration masterbatch.

In each of Examples 1 to 4 and Comparative Examples 1 to 8, a resin molded product uniformly colored in black was obtained. Table 1 shows the measurement results about the number of occurrences of scorching per 1000 m of each molded product and the gel fraction (crosslinking degree) after a hydrothermal treatment (95° C.) for 5 hours.

TABLE 1

| | Number of Occurrences | |
|---|---|---|
| | of Scorching | Gel Fraction |
| | (number/1000 m) | (%) |
| Example 1 | 0 | 76.8 |
| Example 2 | 0 | 77.4 |
| Example 3 | 0 | 76.4 |
| Example 4 | 0 | 76.5 |
| Comparative Example 1 | 13 | 76.7 |
| Comparative Example 2 | 0 | 30.1 |
| Comparative Example 3 | 17 | 75.9 |
| Comparative Example 4 | 0 | 25.9 |
| Comparative Example 5 | 11 | 76.6 |
| Comparative Example 6 | 0 | 28.1 |
| Comparative Example 7 | 15 | 75.9 |
| Comparative Example 8 | 0 | 28.8 |

As shown in Table 1, each of Examples 1 to 4 could achieve a silane crosslinked polyethylene resin that did not undergo scorching and was sufficiently crosslinked at a gel fraction of 75% or higher after the crosslinking treatment. On the other hand, in each of Comparative Examples 1, 3 5, and 7, the gel fraction was 75% or higher, but scorching occurred 13 times or more per 1000 m. Each of Comparative Examples 2, 4, 6, and 8 achieved a silane crosslinked polyethylene resin that did not undergo scorching but was not sufficiently crosslinked at a relatively low gel fraction after the crosslinking treatment.

As described above, according to the conventional method of dry-blending a color masterbatch for blending, it is difficult to avoid scorching when molding a silane crosslinked polyethylene resin. Meanwhile, when a silane crosslinked polyethylene resin is molded in the state where a silanol condensation catalyst is not blended for preventing scorching, scorching can be prevented. In this case, however, crosslinking does not sufficiently progress even if a crosslinking treatment is carried out after molding. Also, a crosslinking reaction may further progress by performing a crosslinking treatment for a longer time period, but productivity is to be significantly impaired.

On the other hand, according to the manufacturing method of the present invention by which a silane crosslinked polyethylene resin molded by blending a silanol condensation catalyst and having a temperature equal to or higher than the melting point is immersed in an oil-soluble dye solution for coloring, it becomes possible to obtain a molded product formed of a colored silane crosslinked polyethylene resin without causing scorching, and also possible to sequentially carry out molding and coloring without impairing productivity.

### REFERENCE SIGNS LIST

1 extruder, 2 coloring bath, 2a oil-soluble dye solution, 3 cleaning bath, 3a water, 4 water-cooling bath, 4a water, 5a resin molded product before coloring, 5b colored resin molded product, 5c core member, 6 liquid colorant spray device, 6a oil-soluble dye solution, 7 liquid colorant dripping device, 7a oil-soluble dye solution, 8 roll, 9 pulling-out unit, 10 pulling-in unit, 11 roll, 12 molded product, 13 liquid, 14 pump, 15 hole.

1. A method of manufacturing a molded product of a silane crosslinked polyethylene resin, said method comprising the steps of:
melting a silane crosslinked polyethylene resin;
extrusion-molding said melted resin;
bringing a surface of a molded product obtained by said extrusion molding into contact with an oil-soluble dye solution before at least said surface solidifies;
separating said molded product from the oil-soluble dye solution; and
cooling said molded product separated from the oil-soluble dye solution.

2. The method of manufacturing a molded product according to claim 1, wherein said step of bringing a surface of a molded product obtained by said extrusion molding into contact with an oil-soluble dye solution before at least said surface solidifies is the step of immersing said molded product in the oil-soluble dye solution.

3. The method of manufacturing a molded product according to claim 1, wherein said step of bringing a surface of a molded product obtained by said extrusion molding into contact with an oil-soluble dye solution before at least said surface solidifies is the step of splaying the oil-soluble dye solution on said molded product.

4. The method of manufacturing a molded product according to claim 1, wherein said step of cooling said molded product separated from the oil-soluble dye solution is the step of water-cooling said molded product.

5. The method of manufacturing a molded product according to claim 1, wherein a solvent used for said oil-soluble dye solution is alcohols or ketones, or a mixture of two or more types thereof.

6. The method of manufacturing a molded product according to claim 1, wherein a silanol condensation catalyst is mixed with said silane crosslinked polyethylene resin in said step of melting a silane crosslinked polyethylene resin.

7. A method of manufacturing a rod-shaped molded product of a silane crosslinked polyethylene resin, said method comprising the steps of:
feeding a core member made of a metal wire rod;
melting a silane crosslinked polyethylene resin;
extrusion-molding the core member in a rod shape while coating an outer circumference of said core member with said resin;
bringing a surface of a molded product obtained by said extrusion molding into contact with an oil-soluble dye solution before at least said surface solidifies;
separating said molded product from the oil-soluble dye solution; and
cooling the molded product separated from the oil-soluble dye solution.

8. A manufacturing apparatus for a rod-shaped molded product of a silane crosslinked polyethylene resin, said manufacturing apparatus comprising:
a pulling-out unit feeding a core member made of a metal wire rod;
a melting unit melting a silane crosslinked polyethylene resin;
an extruder extrusion-molding the core member in a rod shape while coating an outer circumference of said core member with said resin;
a coloring bath in which a surface of a molded product obtained by said extrusion molding is brought into contact with an oil-soluble dye solution before at least said surface solidifies; and
a cooling bath in which the molded product separated from said oil-soluble dye solution is cooled.

9. The manufacturing apparatus according to claim 8, wherein a cooling mechanism for the oil-soluble dye solution is provided in the coloring bath in which said surface is brought into contact with the oil-soluble dye solution.

10. The manufacturing apparatus according to claim 8, wherein an oil-soluble dye concentration adjustment mechanism for the oil-soluble dye solution is provided in the coloring bath in which said surface is brought into contact with the oil-soluble dye solution.
